(19) United States
(12) Patent Application Publication
(10) Pub. No.: US 2026/0057785 A1
(43) Pub. Date: Feb. 26, 2026

(54) METHOD FOR CONTROLLING OPERATION OF AERIAL VEHICLE AND APPARATUS FOR THE SAME

(71) Applicants: Hyundai Motor Company, Seoul (KR); Kia Corporation, Seoul (KR)

(72) Inventors: Jae Jun HA, Hwaseong-si (KR); Young Jun Moon, Sejong-si (KR)

(21) Appl. No.: 19/371,070

(22) Filed: Oct. 28, 2025

Related U.S. Application Data
(62) Division of application No. 17/730,316, filed on Apr. 27, 2022.

(30) Foreign Application Priority Data
Jun. 29, 2021 (KR) 10-2021-0084990

(51) Int. Cl. G08G 5/22; B64F 1/36; G08G 5/55; G08G 5/59

(52) U.S. Cl. CPC G08G 5/22; B64F 1/36; G08G 5/55; G08G 5/59

(57) ABSTRACT

An embodiment method for controlling operation of an aerial vehicle in an aerial vehicle control system includes approving entry of the aerial vehicle into an aerial vehicle operation zone from a take-off and landing facility of a departure location built into the aerial vehicle control system, controlling an operation of the aerial vehicle in the aerial vehicle operation zone, and approving exit of the aerial vehicle from the aerial vehicle operation zone into a take-off and landing facility of a destination location.

### CROSS-REFERENCE TO RELATED APPLICATIONS

This application is a divisional application of U.S. application Ser. No. 17/730,316, filed Apr. 27, 2022, which claims the benefit of Korean Patent Application No. 10-2021-0084990, filed on Jun. 29, 2021, which application is hereby incorporated herein by reference.

### TECHNICAL FIELD

The present disclosure relates to a method and apparatus for controlling an aerial vehicle.

### BACKGROUND

Next-generation mobilities such as the urban air mobility (UAM) and the personal air vehicle (PAV) have been devised to overcome the limitations of the existing means of transportation running on the ground and to travel in the three-dimensional space. Unlike the traditional means of aviation transport including existing aircraft and helicopters, those next-generation air mobilities are being developed to take off and land in various types of spaces without a separate large facility dedicated to take-off and landing.

### SUMMARY

The present disclosure relates to a method and apparatus for controlling an aerial vehicle. Particular embodiments relate to a method and apparatus for controlling an aerial vehicle in a set operation zone.

When next-generation air mobilities are widely distributed, the air mobilities are supposed to operate in a prearranged altitude zone under air control. Nevertheless, due to characteristics of aerial vehicles, numerous aerial vehicles may have to move or operate at the same time.

Accordingly, in order to control smoothly the movement or operation of aerial vehicles, it is necessary to set a zone in which aerial vehicles may operate, and a method and system are also demanded for controlling the movement or operation of aerial vehicles in the zone thus set.

Embodiments of the present invention provide a structure of an operation management system which manages and controls information necessary for operation control of an aerial vehicle.

Also, embodiments of the present invention provide a method and apparatus for setting an airspace, in which an aerial vehicle may be efficiently moved, and for controlling the operation of an aerial vehicle in the set airspace.

According to an embodiment of the present disclosure, a method for controlling operation of an aerial vehicle may be provided. The method may include approving entry of the aerial vehicle from a take-off and landing facility of a departure, which is built into an aerial vehicle control system, to an aerial vehicle operation zone, controlling operation of the aerial vehicle in the aerial vehicle operation zone, and approving exit of the aerial vehicle from the aerial vehicle operation zone into a take-off and landing facility of a destination.

In an embodiment of the present disclosure, the aerial vehicle operation zone may be set based on a road zone in which a vehicle is operated.

In an embodiment of the present disclosure, the aerial vehicle operation zone may be set as a zone at a predetermined height and higher above a road zone in which a vehicle is operated.

In an embodiment of the present disclosure, the aerial vehicle operation zone may be set as a zone at a predetermined height and higher above a neighboring zone of a road.

In an embodiment of the present disclosure, the neighboring zone of the road may be set as a zone a preset distance from a road zone.

In an embodiment of the present disclosure, the aerial vehicle operation zone may include at least one first operation zone and at least one second operation zone.

In an embodiment of the present disclosure, the at least one first operation zone may be managed as a course above the at least one second operation zone.

In an embodiment of the present disclosure, based on a type of the aerial vehicle, the aerial vehicle moving in the at least one first operation zone and the aerial vehicle moving in the at least one second operation zone may be set.

In an embodiment of the present disclosure, the at least one first operation zone may be set as a relatively higher zone than the at least one second operation zone.

In an embodiment of the present disclosure, a process of controlling an operation of the aerial vehicle may include checking a speed of the aerial vehicle and setting, based on the checked speed, an operation zone in which the aerial vehicle is to be operated.

In an embodiment of the present disclosure, the aerial vehicle operation zone may include a supplementary operation zone capable of expanding an operation zone either vertically or horizontally.

In an embodiment of the present disclosure, the aerial vehicle operation zone may include a supplementary operation zone in which, according to a type of obstacle, at least one of a location of a zone, a size of the zone, and a shape of the zone is adaptively set.

In an embodiment of the present disclosure, by considering a location of a fixed obstacle, the supplementary operation zone may be set as a zone that is obtained by expanding the aerial vehicle operation zone either horizontally or vertically.

In an embodiment of the present disclosure, by considering a movement direction and speed of a movable obstacle, the supplementary operation zone may be set as at least one zone among zones that are obtained by expanding the aerial vehicle operation zone horizontally or vertically.

In an embodiment of the present disclosure, the road zone may include a first road zone, in which a moving object moves in a first direction, and a second road zone in which a moving object moves in a second direction opposite to the first direction.

In an embodiment of the present disclosure, the take-off and landing facility may be provided next to either the first road zone or the second road zone.

In an embodiment of the present disclosure, the take-off and landing facility may be provided between the first road zone and the second road zone.

In an embodiment of the present disclosure, an entry section of a path from the take-off and landing facility to the aerial vehicle operation zone and an exit section of a path from the aerial vehicle operation zone to the take-off and landing facility may be included.

In an embodiment of the present disclosure, a method for controlling operation of an aerial vehicle may further include transferring control right of the aerial vehicle to the personal aerial vehicle or a control server by considering an operation zone of the aerial vehicle, an entry section and an exit section.

In an embodiment of the present disclosure, a method for controlling operation of an aerial vehicle may further include detecting occurrence of an abnormal situation in the aerial vehicle operation zone and transferring control right of the aerial vehicle to a control server.

In an embodiment of the present disclosure, a process of controlling operation of the aerial vehicle may include receiving, by a local control server provided in the aerial vehicle or the take-off and landing facility, operation information from a central control server and controlling operation of the aerial vehicle by reflecting the operation information.

In an embodiment of the present disclosure, a method for controlling operation of an aerial vehicle may include a process of configuring and providing, by the central control server, the operation information which includes at least one among weather information, congestion information, an altitude range of an aerial vehicle operation zone, and event information occurring in the aerial vehicle operation zone.

In an embodiment of the present disclosure, a method for controlling operation of an aerial vehicle may include checking, by the local control server, a condition of a stop included in the take-off and landing facility or a condition of a take-off and landing field.

In an embodiment of the present disclosure, a method for controlling operation of an aerial vehicle may further include checking a degree of congestion in the take-off and landing facility based on the condition of the stop or the condition of the take-off and providing the degree of congestion.

In an embodiment of the present disclosure, a method for controlling operation of an aerial vehicle may include transmitting an approval request message to the central control server and performing, by the central control server, approval for entry of the personal aerial vehicle into an aerial vehicle operation zone.

In an embodiment of the present disclosure, an approval request message may include at least one among an aerial vehicle identifier of the aerial vehicle, aerial vehicle type information, an approval request command, destination information, user information and an identifier of a local control server.

In an embodiment of the present disclosure, a method for controlling operation of an aerial vehicle may include configuring, by the central control server, charging information based on departure information and destination information.

In an embodiment of the present disclosure, a method for controlling operation of an aerial vehicle may include receiving, by the personal aerial vehicle, an approval response message including an approval result from the central control server and entering the aerial vehicle operation zone according to the approval result.

In an embodiment of the present disclosure, a method for controlling operation of an aerial vehicle may further include providing, by the central control server, operation information to the personal aerial vehicle that moves in the aerial vehicle operation zone.

In an embodiment of the present disclosure, a method for controlling operation of an aerial vehicle may include transmitting, by the personal aerial vehicle, a landing approval request message, receiving a landing approval response message, and controlling entry into the take-off and landing facility based on information included in the landing approval response message.

In an embodiment of the present disclosure, the landing approval response message may include information indicating a zone at which the personal aerial vehicle is to land.

In an embodiment of the present disclosure, a method for controlling operation of an aerial vehicle may include confirming, by the central control server, departure information or destination information by using an identifier of the local control server.

In an embodiment of the present disclosure, the take-off and landing facility may be provided close to a ramp section of an expressway, in which the moving object is moved, or a service facility of the expressway.

In an embodiment of the present disclosure, the take-off and landing facility may include a stop, in which an aerial vehicle or a moving object may stop, and a take-off and landing field in which an aerial vehicle may take off and land.

According to another embodiment of the present disclosure, a take-off and landing facility apparatus may be provided. In a facility apparatus for supporting at least one moving object and take-off and landing of at least one aerial vehicle, the facility apparatus may include a moving object stop, in which at least one moving object stops, an aerial vehicle stand, in which at least one aerial vehicle stands, a take-off and landing field in which the at least one aerial vehicle takes off and lands, and a server apparatus capable of controlling an operation of the at least one moving object or the at least one aerial vehicle.

According to yet another embodiment of the present disclosure, a central control server apparatus may be provided to an aerial vehicle control system. The central control server apparatus may include a communication unit capable of communicating with at least one aerial vehicle and a local control server, which are provided in an aerial vehicle control system, at least one storage medium, and at least one processor.

The at least one processor may be configured to approve the at least one aerial vehicle to enter an aerial vehicle operation zone, to control operation in the aerial vehicle operation zone, and to control the entry of the at least one aerial vehicle into a take-off and landing facility.

According to yet another embodiment of the present disclosure, a local control server apparatus may be provided. The local control server apparatus may include a communication unit capable of communicating with at least one aerial vehicle and a central control server, which are provided in an aerial vehicle control system, at least one storage medium, and at least one processor.

The at least one processor may be configured to control the take-off and landing of the at least one aerial vehicle, to control the entry of the at least one aerial vehicle into a take-off and landing facility, and to manage the at least one aerial vehicle in the take-off and landing facility.

According to embodiments of the present invention, a method and apparatus for setting a space of operating an aerial vehicle and for controlling the aerial vehicle to be operated in the set space may be provided.

Also, according to embodiments of the present invention, a method and apparatus for controlling an aerial vehicle efficiently in a set space may be provided.

### BRIEF DESCRIPTION OF THE DRAWINGS

FIGS. 1A to 1C are views illustrating operation zones for a personal aerial vehicle used in an aerial vehicle control system according to an embodiment of the present disclosure.

FIG. 2A is a view illustrating a structure of a take-off and landing facility and an aerial vehicle operation zone for an aerial vehicle control system according to an embodiment of the present disclosure.

FIG. 2B is another view illustrating a structure of a take-off and landing facility and an aerial vehicle operation zone for an aerial vehicle control system according to an embodiment of the present disclosure.

FIG. 3A is a conceptual view showing schematically a configuration of an aerial vehicle control system according to an embodiment of the present disclosure.

FIG. 3B is a view illustrating a structure of an aerial vehicle control system according to an embodiment of the present disclosure.

FIG. 4 is a view illustrating an approval operation of an aerial vehicle control system according to an embodiment of the present disclosure.

FIGS. 5A to 5D are views illustrating an approval request message and an approval response message used in an aerial vehicle control system according to an embodiment of the present disclosure.

FIGS. 6A to 6D are views illustrating a take-off approval request message and a take-off approval response message used in an aerial vehicle control system according to an embodiment of the present disclosure.

FIG. 7 is a view illustrating a control operation of an aerial vehicle control system according to an embodiment of the present disclosure.

FIG. 8 is a signal flow diagram illustrating a control right transfer operation of an aerial vehicle control system according to an embodiment of the present disclosure.

FIG. 9 is a signal flow diagram illustrating a control right transfer operation of an aerial vehicle control system according to an embodiment of the present disclosure.

FIG. 10 is a signal flow diagram illustrating a control right transfer operation of an aerial vehicle control system according to an embodiment of the present disclosure.

FIG. 11 is a block diagram illustrating a configuration of a local control server for an aerial vehicle control system according to an embodiment of the present disclosure.

FIG. 12 is a block diagram illustrating a configuration of a central control server for an aerial vehicle system according to an embodiment of the present disclosure.

FIG. 13 is a view illustrating an apparatus configuration according to an embodiment of the present disclosure.

### DETAILED DESCRIPTION OF ILLUSTRATIVE EMBODIMENTS

Hereinafter, embodiments of the present disclosure will be described in detail with reference to the accompanying drawings, which will be easily implemented by those skilled in the art. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked”, “coupled”, or “connected” to another component, it is understood that not only a direct connection relationship but also an indirect connection relationship through an intermediate component may also be included. Also, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc. unless specifically stated otherwise. Thus, within the scope of this disclosure, a first component in one exemplary embodiment may be referred to as a second component in another embodiment, and similarly a second component in one exemplary embodiment may be referred to as a first component in another embodiment.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various exemplary embodiments are not necessarily essential components, and some may be optional components. Accordingly, exemplary embodiments consisting of a subset of the components described in one embodiment are also included within the scope of the present disclosure. Also, exemplary embodiments that include other components in addition to the components described in the various embodiments are also included in the scope of the present disclosure.

Advantages and features of embodiments of the present disclosure, and methods for achieving them will be apparent with reference to the exemplary embodiments described below in detail with reference to the accompanying drawings. However, the present disclosure is not limited to the exemplary embodiments set forth herein but may be embodied in many different forms. The present exemplary embodiments are provided to make disclosed contents of the present disclosure thorough and complete and to completely convey the scope of the disclosure to those with ordinary skill in the art.

Although exemplary embodiments may be described as using a plurality of units to perform the exemplary processes, it is understood that the exemplary processes may also be performed by one or a plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

An aerial vehicle control system according to an embodiment of the present disclosure may include a system for controlling next-generation aerial mobilities such as an urban air mobility (UAM) and a personal air vehicle (PAV). When a configuration or operation of an aerial vehicle control system is described according to an embodiment of the present disclosure, a personal aerial vehicle is used, but the present disclosure does not limit next-generation aerial mobilities to personal aerial vehicles, and various next-generation mobilities may be used.

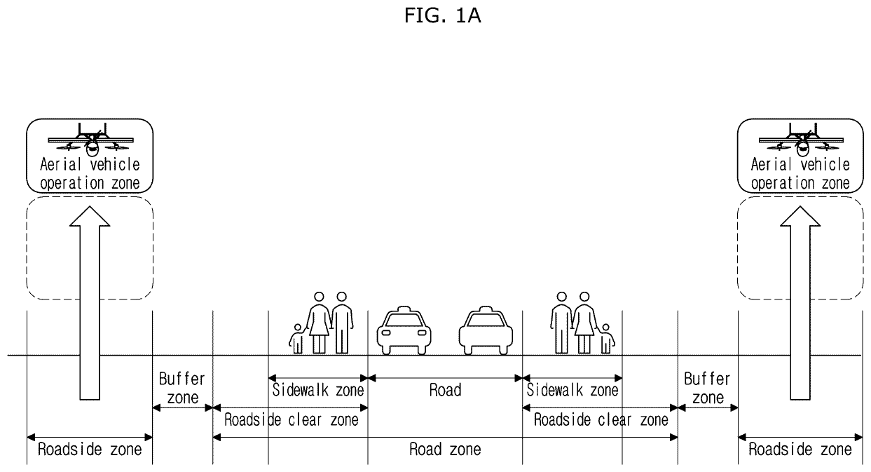

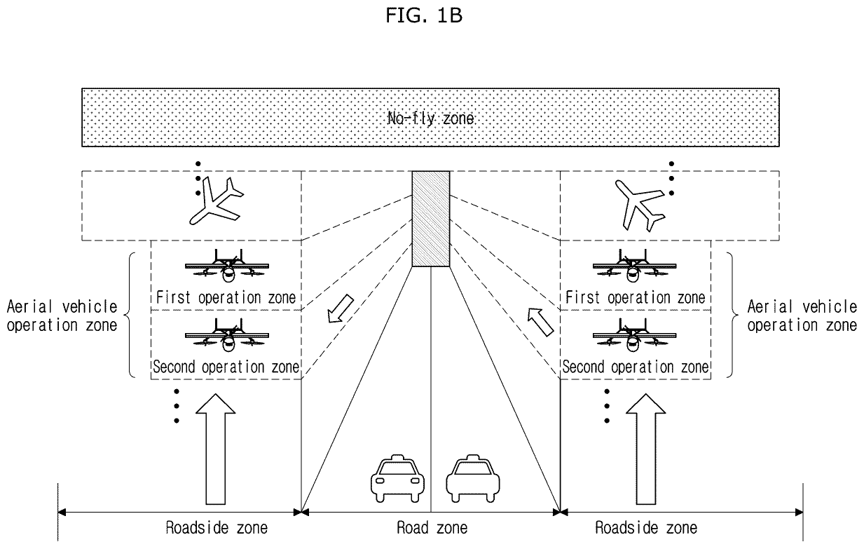

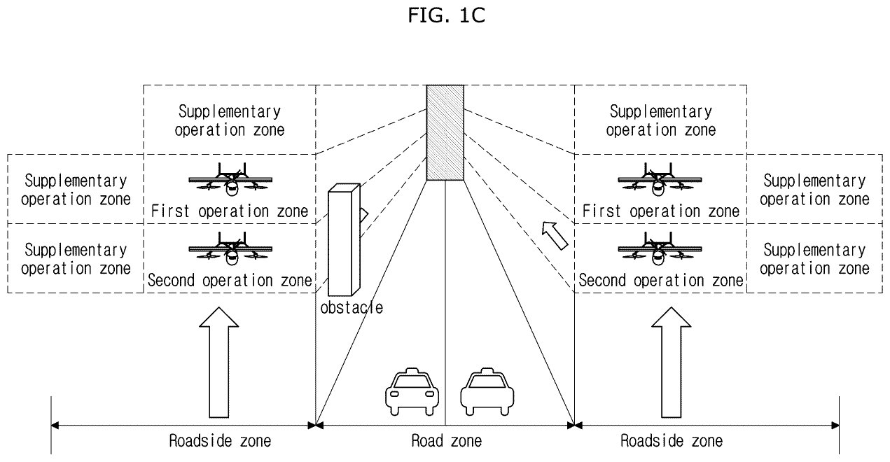

FIGS. 1A to 1C are views illustrating operation zones for an aerial vehicle used in an aerial vehicle control system according to an embodiment of the present disclosure.

In an embodiment of the present disclosure, an aerial vehicle control system may control movement of an aerial vehicle, particularly to enable the aerial vehicle to move in an aerial vehicle operation zone.

First, referring to FIG. 1A, an aerial vehicle operation zone may be set based on a road zone in which a moving object is operated. Herein, the road zone may be a zone on the ground in which a road is set. Herein, the road may include a driveway, in which a moving object is moved, and a sidewalk zone in which people move. As another example, a road zone may include a road zone and a roadside clear zone, which are set according to a road act.

As an example, an aerial vehicle operation zone may be set as a zone at a predetermined height or higher above a road zone. Furthermore, in case a personal aerial vehicle has an abnormality and lands or crashes while operating in an aerial vehicle operation zone set above a road zone, a moving object (or a person) moving in the road zone may be affected. Accordingly, it is desirable that an aerial vehicle operation zone is set vertically above a neighboring zone of a road zone (hereinafter, referred to as “roadside zone”), instead of vertically above the road zone. For example, it is desirable that a preset distance range from a road zone is set as a roadside zone and an aerial vehicle operation zone is set above the roadside zone. Furthermore, a predetermined buffer zone may be set between the road zone and the roadside zone.

Referring to FIG. 1B, an aerial vehicle operation zone may include a plurality of operation zones that are distinguished in a vertical direction. For example, an aerial vehicle operation zone may include a first operation zone and a second operation zone, and the first operation zone may be managed as a higher course than the second operation zone. In addition, a first operation zone may be set and managed as a relatively higher zone than a second operation zone. Accordingly, an aerial vehicle control system may control an aerial vehicle moving at relatively high speed to move in the first operation zone and control an aerial vehicle moving at relatively low speed to move in the second operation zone. As another example, an aerial vehicle control system may manage a second operation zone as a slow lane and a first operation zone as a fast lane.

As yet another example, a type of an aerial vehicle may be set according to size or purpose of use, and a type of an aerial vehicle capable of operating in a plurality of operation zones may be set and managed. As an example, according to purpose of use, aerial vehicles may be classified into passenger aerial vehicles and cargo aerial vehicles. Accordingly, an aerial vehicle control system may control a passenger aerial vehicle to move in the first operation zone and control a cargo aerial vehicle to move in the second operation zone. As another example, according to size, aerial vehicles may be classified into small aerial vehicles, mid-sized aerial vehicles and large aerial vehicles. Correspondingly, an aerial vehicle control system may control an aerial vehicle with relatively large size to operate in a higher course. As an example, an aerial vehicle control system may control a large aerial vehicle to move in the first operation zone and control a small aerial vehicle or a mid-sized aerial vehicle to move in the second operation zone. As yet another example, an aerial vehicle operation zone may include a first operation zone, a second operation zone and a third operation zone, and an aerial vehicle control system may control a large aerial vehicle to move in the first operation zone, a mid-sized aerial vehicle to move in the second operation zone and a small aerial vehicle to move in the third operation zone.

In an embodiment of the present disclosure, a first operation zone, a second operation zone and a third operation zone are described as multiple operation zones, but the present disclosure is not limited thereto, and the number of operation zones may vary.

Referring to FIG. 1C, in an embodiment of the present disclosure, an aerial vehicle operation zone may include a supplementary operation zone capable of expanding an operation zone either vertically or horizontally. For example, there may be an obstacle at a certain point or in a section of an aerial vehicle operation zone, thus a supplementary operation zone may be set to drive by evading the obstacle. As an example, a supplementary operation zone may be configured by expanding an operation zone in vertical direction. As another example, one of 8 directions from an operation path of an aerial vehicle may be set as a supplementary operation zone.

Furthermore, a supplementary operation zone may be configured adaptively according to a type of an obstacle. For example, in case there is a fixed obstacle, an aerial vehicle control system may set a supplementary operation zone in a corresponding section so that an aerial vehicle operation zone may be managed by being temporarily expanded. As another example, in case a movable obstacle is identified, an aerial vehicle control system may identify a movement direction and speed of the movable obstacle and set a supplementary operation zone by selecting one of 8 directions from an operation course of an aerial vehicle as an optimal evasion zone.

As an example, an aerial vehicle operation zone may be set based on a predetermined altitude. As another example, an aerial vehicle operation zone may change its altitude adaptively according to weather information. For example, weather information may include information for identifying weather conditions like snowfall, rainfall, fog and the like, and an altitude range of an aerial vehicle operation zone may be set based on such weather information. An altitude range of an aerial vehicle operation zone may be set in predetermined distance units (e.g., 300 m, 500 m, and 1 km).

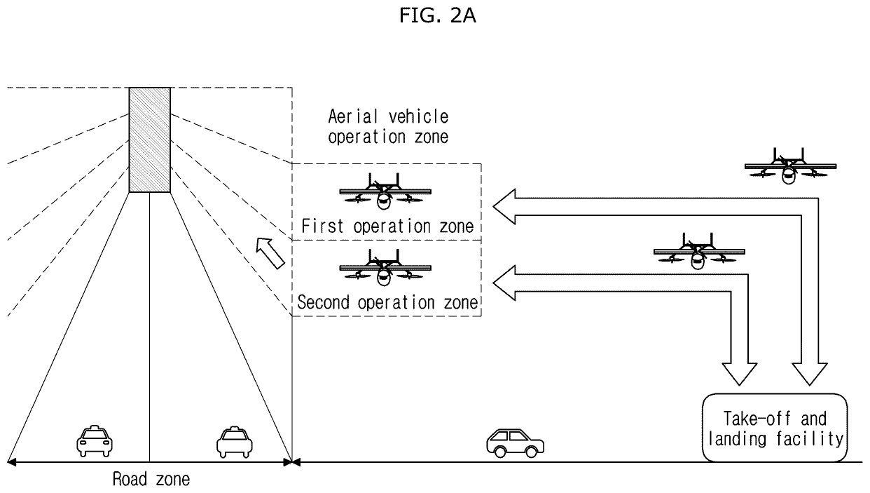

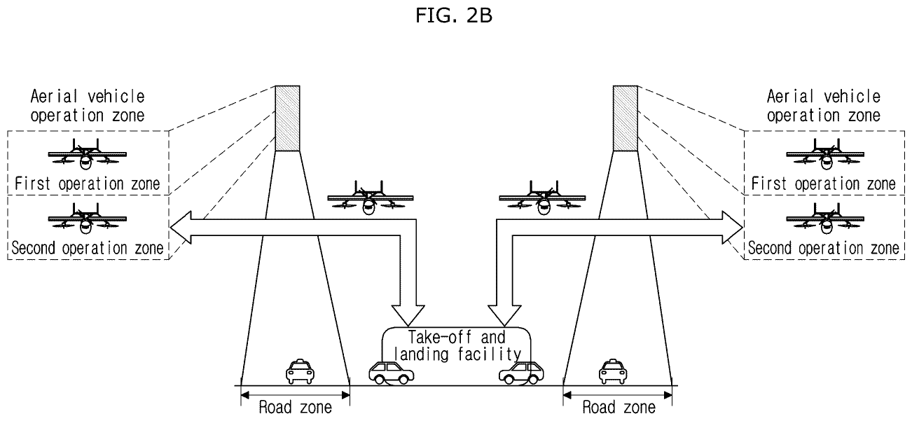

Meanwhile, referring to FIG. 2A, an aerial vehicle may enter an aerial vehicle operation zone restrictedly through a take-off and landing facility. Herein, the take-off and landing facility may include a space, in which an aerial vehicle may take off or land, and a controller capable of controlling entry into and exit from an aerial vehicle operation zone. As an example, the take-off and landing facility may include an expressway tollgate facility, a service facility and the like. Furthermore, it is desirable that the take-off and landing facility is installed at one side or both sides of a road zone.

As another example, referring to FIG. 2B, a road zone may have a northbound lane and a southbound lane separate from each other, and an expressway tollgate facility, a service facility and the like may be installed in the central areas of the northbound lane and the southbound lane respectively. Thus, a take-off and landing facility may be located in the central area of a road zone.

Furthermore, a take-off and landing facility may be connected with a control server that performs control of take-off and landing of an aerial vehicle, control of entry into and exit from an aerial vehicle operation zone, and information exchange with an aerial vehicle. A control server may include a local control server and a central control server. A local control server may include a server that is provided within a take-off and landing facility or adjacent to the take-off and landing facility. In addition, a central control server may include a server that is connected with at least one local control server and performs overall control of an aerial vehicle control system.

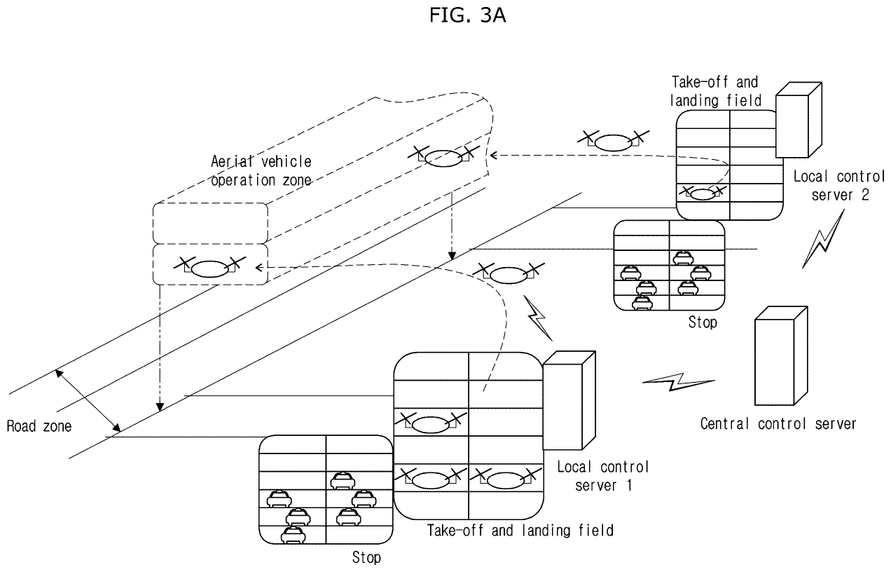

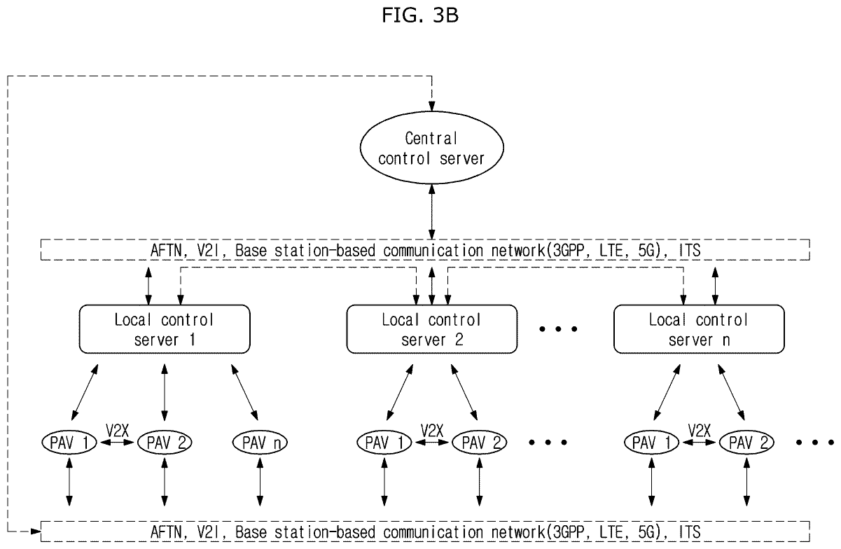

FIG. 3A is a conceptual view showing schematically a configuration of an aerial vehicle control system according to an embodiment of the present disclosure, and FIG. 3B is a view illustrating a structure of an aerial vehicle control system according to an embodiment of the present disclosure.

Referring to FIG. 3A, a take-off and landing facility and an aerial vehicle operation zone may be set, and an aerial vehicle control system may control the movement or operation of a personal aerial vehicle in the take-off and landing facility and the aerial vehicle operation zone.

A take-off and landing facility may include a stop, in which a personal aerial vehicle or a moving object may stop, and a take-off and landing field in which a personal aerial vehicle may take off and land. Herein, the stop and the take-off and landing field may be set as different areas on a single plane. As another example, a take-off and landing facility may include a building constructed with a plurality of floors, and a stop and a take-off and landing field may be set on different floors. As yet another example, a stop may be configured to separate areas in which a personal aerial vehicle or a moving object may stop. For example, a stop may include a first stop, where a personal aerial vehicle stands, and a second stop where a moving object stops. A first stop and a second stop may be set as different areas on a single plane or as different floors. As yet another example, a first stop and a take-off and landing field may be set as different areas on a single plane, and a second stop may be set as a different floor from the first stop and the take-off and landing field.

For example, a personal aerial vehicle may be available in a road zone, a stop, a take-off and landing field, and an aerial vehicle operation zone and may include a moving object with a shape capable of vertical take-off and landing (e.g., vertical take-off and landing (VTOL) and electric vertical take-off and landing (e-VTOL)). Accordingly, a personal aerial vehicle may move from a road zone to a stop, a take-off and landing field, and the like and move from the take-off and landing field to an aerial vehicle operation zone under the control of a control server (local control server or central control server). In addition, under the control of a control server (local control server or central control server), a personal aerial vehicle may move from an aerial vehicle operation zone to a take-off and landing field.

Furthermore, in an embodiment of the present disclosure, a section in which a personal aerial vehicle is moved from a take-off and landing field to an aerial vehicle operation zone is called an entry section, and a section in which the personal aerial vehicle is moved from the aerial vehicle operation zone to the take-off and landing field is called an exit section.

Meanwhile, a central control server may be connected with a local control server via a communication network and receive information on a personal aerial vehicle from the local control server. In addition, the central control server may provide the local control server with information necessary to control a personal aerial vehicle or to control an entry section or an exit section. In addition, the central control server may provide operation information necessary for a personal aerial vehicle to operate in an aerial vehicle operation zone. Meanwhile, although a personal aerial vehicle may freely move in a take-off and landing field, an entry section, an exit section and an aerial vehicle operation zone, as personal aerial vehicles move at relatively high speed, an accident is very likely to happen in the take-off and landing field, the entry section and the exit section. Accordingly, it is necessary to set control rights for movement or operation by distinguishing a local control server, a central control server, a personal aerial vehicle and the like according to a location or situation of the personal aerial vehicle.

Referring to FIG. 3B, an aerial vehicle control system according to an embodiment of the present disclosure may include a local control server, a central control server, and a personal aerial vehicle, and the local control server, the central control server, and the personal aerial vehicle may exchange information necessary for control via communication. Also, a personal aerial vehicle may control movement or operation based on information received from a local control server and a central control server.

A personal aerial vehicle and a local control server may be connected with each other based on a vehicle to everything (V2X) communication scheme, and the personal aerial vehicle and a central control server may be connected with each other based on a vehicle to everything (V2X) communication scheme. As an example, it is desirable that a personal aerial vehicle and a local control server are connected to each other through a vehicle to infrastructure (V2I) scheme and the personal aerial vehicle and a central control server are connected to each other through a V2I scheme. A personal aerial vehicle and a local control server may be connected with each other via an aeronautical telecommunication network (AFTN), and the personal aerial vehicle and a central control server may be connected with each other via an AFTN. As yet another example, a personal aerial vehicle and a local control server may be connected with each other via a base station-based communication network, and the personal aerial vehicle and a central control server may be connected with each other via a base station-based communication network. As an example, a base station-based communication network may include a cellular communication network, a communication network based on 3rd generation partnership project (3GPP), a communication network based on long term evolution (LTE), and a communication network based on fifth generation (5G) technology standard. Although, in an embodiment of the present disclosure, a communication network based on 3rd generation partnership project (3GPP), a communication network based on long term evolution (LTE), and a communication network based on fifth generation (5G) technology standard are described as examples of base station-based communications, but the present disclosure is not limited thereto, and various types of cellular communication networks may be used.

Furthermore, an aerial vehicle control system according to an embodiment of the present disclosure may configure different communication networks connecting a local control server or a central control server according to a location of a personal aerial vehicle. As an example, in case a personal aerial vehicle exists within a take-off and landing facility or exists in an entry section or an exit section, the personal aerial vehicle may be connected with a local control server based on an X2V scheme. In addition, in case the personal aerial vehicle exists in an aerial vehicle operation zone, the personal aerial vehicle may be connected with the central control server (or local control server) via an AFTN or cellular communication network.

In addition, a personal aerial vehicle may be connected with another personal aerial vehicle through a V2X scheme. Thus, a personal aerial vehicle may be connected with another neighboring personal aerial vehicle through a V2X scheme, and a distance between neighboring personal aerial vehicles may be measured so that a collision between personal aerial vehicles may be prevented.

Basically, a central control server may set an operation condition in an aerial vehicle control system such as an entry section, an exit section, an aerial vehicle operation zone, and the like and set and provide a control parameter matching the operation condition to a local control server or a personal aerial vehicle. Herein, the operation condition may include a speed, an interval, a set altitude of an aerial vehicle operation zone and the like.

Furthermore, a central control server may check and store a weather condition necessary to set an operation condition. To this end, the central control server may be connected with a device (or server) capable of providing weather information via a communication network and receive and store weather information periodically. As another example, the central control server may receive and store weather information from a device (or server) capable of providing weather information whenever a preset condition (e.g., lightning, gale, storm, heavy rainfall) is satisfied.

Also, a central control server may manage operation information of a personal aerial vehicle operated within an aerial vehicle control system and identify and manage a degree of congestion of each section of an aerial vehicle operation zone based on the operation information.

Also, a central control server may identify and manage event information (e.g., accident, obstacle, emergency situation) occurring within an aerial vehicle operation zone.

Also, a central control server may perform network linkage between local control servers, management of situations in a take-off and landing facility connected to a local control server, and the like.

Meanwhile, a local control server may manage the control right of a personal aerial vehicle in an entry section, an exit section, and an aerial vehicle operation zone. As an example, a local control server may set the control right of a personal aerial vehicle to a local control server or to a personal aerial vehicle. To this end, a local control server may receive information required to set the control right of a personal aerial vehicle from the personal aerial vehicle, and then set up and manage the control right for the personal aerial vehicle based on the received information.

Also, a local control server may identify and manage a condition of a stop, a condition of a take-off and landing field, and the like. For example, the condition of a stop may include an occupancy state of a spot included in the stop, an identifier of a moving object or a personal aerial vehicle present at the occupied spot, and the like. Likewise, the condition of a take-off and landing field may include an occupancy state of a spot included in the take-off and landing field, an identifier of a personal aerial vehicle present at the occupied spot, and the like. Furthermore, a local control server may identify and manage a degree of congestion in a take-off and landing facility based on a condition of a stop, a condition of a take-off and landing field, and the like.

Furthermore, a local control server may check and store the above-described weather condition. As an example, a local control server may receive and store weather information from a central control server. As another example, a local control server may be connected with a device (or server) capable of providing weather information via a communication network and receive and store weather information periodically. Also, a local control server may store and manage operation conditions like an entry section, an exit section, and an aerial vehicle operation zone. An operation condition may be received from a central control server and be managed.

Also, a local control server may identify and manage event information (e.g., accident, obstacle, emergency situation) occurring within an aerial vehicle operation zone. Event information may be received from a central control server or be generated based on a degree of congestion of a take-off and landing facility, weather information and the like.

Meanwhile, like a conventional personal aerial vehicle, a personal aerial vehicle may be controlled to move in a predetermined airspace, and the movement may be controlled through a user's operation control or autonomous driving control. Particularly, the movement or operation of a personal aerial vehicle may be controlled in a take-off and landing field, an entry section, an exit section, and an aerial vehicle operation zone, and the movement or operation may be controlled based on information received from a local control server or a central control server. Furthermore, the control right of a personal aerial vehicle may be determined according to a zone that is set in an aerial vehicle control system, and movement or operation may be controlled in response to the determined control right.

Hereinafter, an operation of an aerial vehicle control system will be described in detail in accordance with an embodiment of the present disclosure.

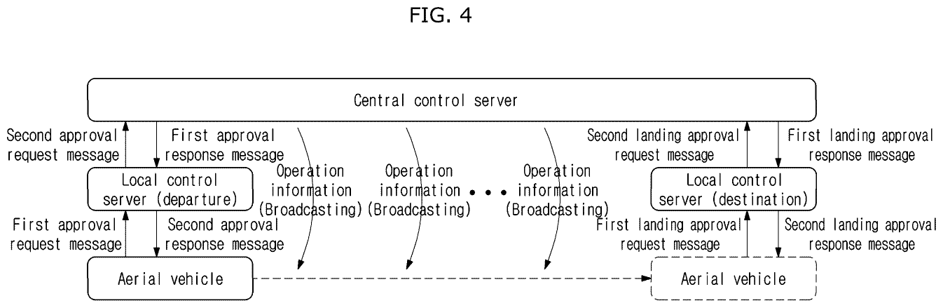

FIG. 4 is a view illustrating an approval operation of an aerial vehicle control system according to an embodiment of the present disclosure.

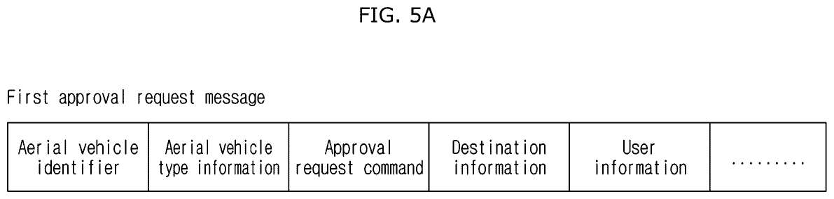

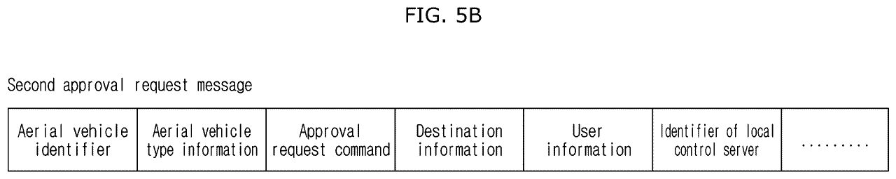

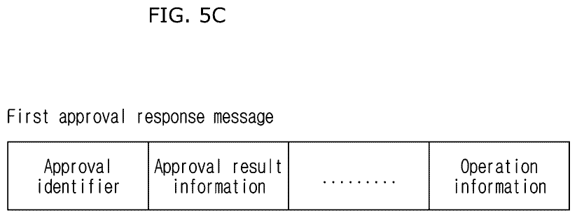

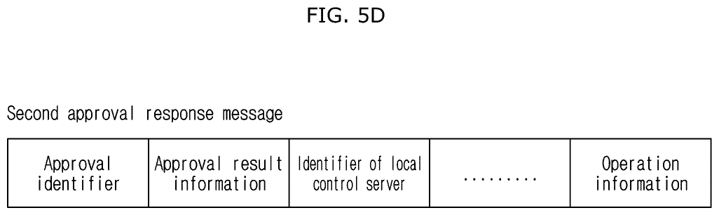

Referring to FIG. 4, first, a personal aerial vehicle may transmit a first approval request message to a local control server, and the local control server may configure a second approval request message based on the first approval request message. In addition, the local control server may deliver the second approval request message to a central control server. Herein, the first approval request message (refer to FIG. 5A) may include an aerial vehicle identifier of a personal aerial vehicle, aerial vehicle type information, an approval request command, destination information, and user information. In addition, the second approval request message (refer to FIG. 5B) may include an aerial vehicle identifier of a personal aerial vehicle, aerial vehicle type information, an approval request command, destination information, user information, and an identifier of the local control server. Herein, the aerial vehicle type information may include a type (e.g., large, mid-sized, small) that is determined based on a size of an aerial vehicle. In addition, the aerial vehicle type information may include a type (e.g., passenger, cargo) that is determined based on a purpose of use of an aerial vehicle.

The central control server may confirm information included in the second approval request message and perform approval for entry of a personal aerial vehicle into an aerial vehicle operation zone. The central control server may determine whether or not to approve and may transmit a first approval response message including a determined result to the local control server. In response to this, the local control server may configure a second approval response message based on the first approval response message and may deliver the second approval response message to the personal aerial vehicle. Herein, the first approval response message (refer to FIG. 5C) may include an approval identifier, approval result information, operation information, and the like, and the second approval response message (refer to FIG. 5D) may include an approval identifier, approval result information, an identifier of a local control server, operation information, and the like.

In addition, the central control server may identify departure information based on the identifier of the local control server included in the second approval request message. The central control server may store and manage information included in the second approval request message and, in particular, may configure and manage charging information based on departure information and destination information.

As another example, the second approval response message may include an identifier of a local control server, and the personal aerial vehicle may store temporarily the identifier of the local control server as departure information. The departure information may be used by the personal aerial vehicle to configure charging information in an exit section of the destination.

In addition, the central control server may configure and provide operation information of a section in which the personal aerial vehicle moves based on departure information and destination information. Herein, the operation information may include weather information, congestion information (e.g., traffic information) and the like. The operation information may be included in the first approval response message or the second approval response message. As another example, the operation information may be configured as a separate message and be delivered to the local control server or the personal aerial vehicle.

Meanwhile, when approval is completed by the central control server and the local control server, the personal aerial vehicle may enter an aerial vehicle operation zone under the control of the local control server. The central control server may broadcast the operation information by a predetermined time, and in the aerial vehicle operation zone, the personal aerial vehicle may receive the broadcast information and use the broadcast information to control a moving object. As an example, the personal aerial vehicle may perform speed control of the aerial vehicle or change of an operation section by considering weather information or may perform change of an operation section by considering congestion information (e.g., traffic information).

Although an embodiment of the present disclosure illustrates that a central control server broadcasts operation information, it does not limit the present disclosure and may be modified in various ways. For example, within an aerial vehicle operation zone, a personal aerial vehicle may perform connection of a wireless communication network with a central control server and receive the above-described operation information via the connected communication network. Thus, in an aerial vehicle operation zone, when a personal aerial vehicle and a central control server are connected via a wireless communication network, the control right may be transferred adaptively to the central control server in response to worsening weather conditions, emergency situations, and the like.

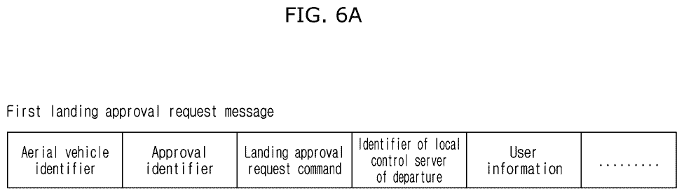

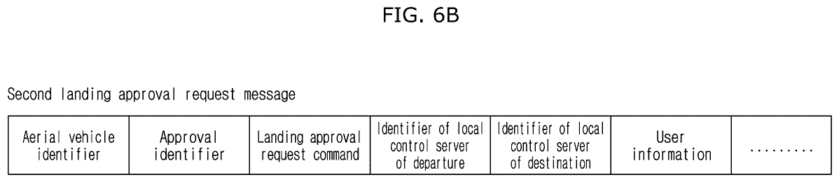

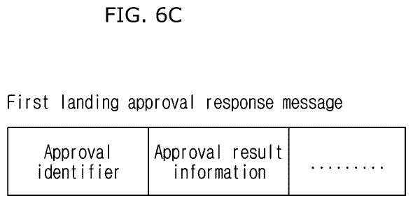

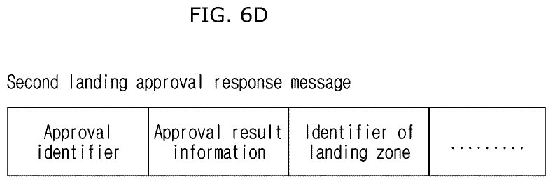

Meanwhile, when a personal aerial vehicle approaches a local control server of a destination, the personal aerial vehicle may transmit a first landing approval request message to the local control server, and the local control server may configure a second landing approval request message based on the first landing approval request message and deliver the second landing approval request message to the central control server. Herein, the first landing approval request message (refer to FIG. 6A) may include an aerial vehicle identifier of the personal aerial vehicle, an approval identifier, a landing approval request command, an identifier of the local control server of the departure, user information, and the like. Furthermore, the second landing approval request message (refer to FIG. 6B) may include an aerial vehicle identifier of the personal aerial vehicle, an approval identifier, a landing approval request command, an identifier of the local control server of the departure, an identifier of the local control server of the destination, user information, and the like. In response to this, the central control server may confirm information included in the second landing approval request message and determine landing approval for the corresponding personal aerial vehicle. Herein, the central control server may configure a first landing approval response message (refer to FIG. 6C) including an approval identifier and landing approval result information and provide the first landing approval response message to a local control server of a destination, and the local control server of the destination may configure a second landing approval response message (refer to FIG. 6D) based on the first landing approval response message, including an approval identifier, approval result information, and an identifier of a landing zone, and deliver the second landing approval response message to the personal aerial vehicle.

Although, in an embodiment of the present disclosure, it is described that a central control server determines a landing approval for a corresponding personal aerial vehicle by using a second landing approval request message, but the present disclosure is not limited thereto. As another example, a local control server of a destination may determine a landing approval and provide a landing approval result to a central control server. In this case, the local control server of the destination may configure a landing approval request message including a landing approval result and provide the landing approval request message to the personal aerial vehicle. In addition, the included local control server of the destination may configure a second landing approval request message including the landing approval result and provide the second landing approval request message to the central control server. Accordingly, the central control server may configure charging information using information included in the second landing approval request message and provide the configured charging information to the local control server or the personal aerial vehicle.

In addition, the local control server may check a status of a take-off and landing field of the destination and identify a landing zone in which landing is possible. In addition, the local control server may configure a second landing approval response message including the identified landing zone.

Based on information transmitted and received through the approval request message, the approval response message, the landing approval request message, and the landing approval response message, which are described above, the personal aerial vehicle may perform an operation in an aerial vehicle operation zone. Furthermore, as it is necessary to set the control right for movement or operation by distinguishing a local control server, a central control server, a personal aerial vehicle and the like according to a location or situation of the personal aerial vehicle, an operation of setting the control right will be described in detail.

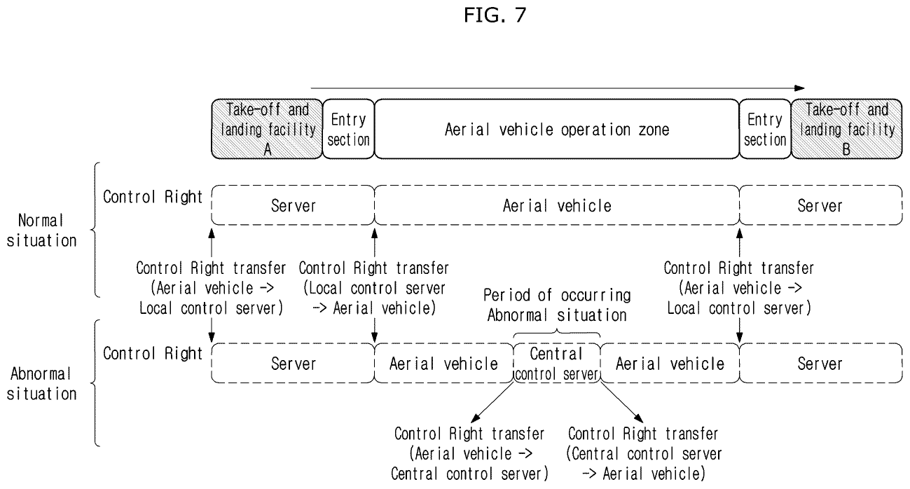

FIG. 7 is a view illustrating a control right operation of an aerial vehicle control system according to an embodiment of the present disclosure.

Referring to FIG. 7, a personal aerial vehicle may be moved in a take-off and landing facility, an entry section, an aerial vehicle operation zone, an exit section, and the like.

A personal aerial vehicle may be driven at a constant speed in an aerial vehicle operation zone, but a degree of congestion may be high in a take-off and landing facility, and a collision with another personal aerial vehicle may occur in an entry section or in an exit section. Accordingly, in a take-off and landing facility, an entry section, and an exit section, it is desirable that operation control of a personal aerial vehicle is performed by a local control server or a central control server rather than by the personal aerial vehicle itself. Accordingly, while a personal aerial vehicle enters a take-off and landing facility and an entry section, it is desirable that the control right of the personal aerial vehicle is transferred from the personal aerial vehicle to a control server (local control server or central control server). After the personal aerial vehicle enters an aerial vehicle operation zone, it is desirable that the control right is transferred from the control server (local control server or central control server) to the personal aerial vehicle. In addition, while the personal aerial vehicle enters an entry section or a take-off and landing facility, it is desirable that the control right is transferred from the personal aerial vehicle to the control server (local control server or central control server).

Furthermore, while the personal aerial vehicle is being operated in an aerial vehicle operation zone, an abnormal situation may occur in a specific section, and such an abnormal situation may not be predicted or detected by a user, thereby resulting in an accident. Accordingly, the central control server needs to detect whether or not an abnormal situation occurs in an aerial vehicle operation zone, and it is desirable that the control right is transferred from the personal aerial vehicle to the control server (local control server or central control server), when an abnormal situation occurs.

Considering what is described above, an aerial vehicle control system according to an embodiment of the present disclosure may be configured to transfer the control right of a personal aerial vehicle. For example, a control server (local control server or central control server) may identify a location of a personal aerial vehicle and process control right transfer through communication with the personal aerial vehicle.

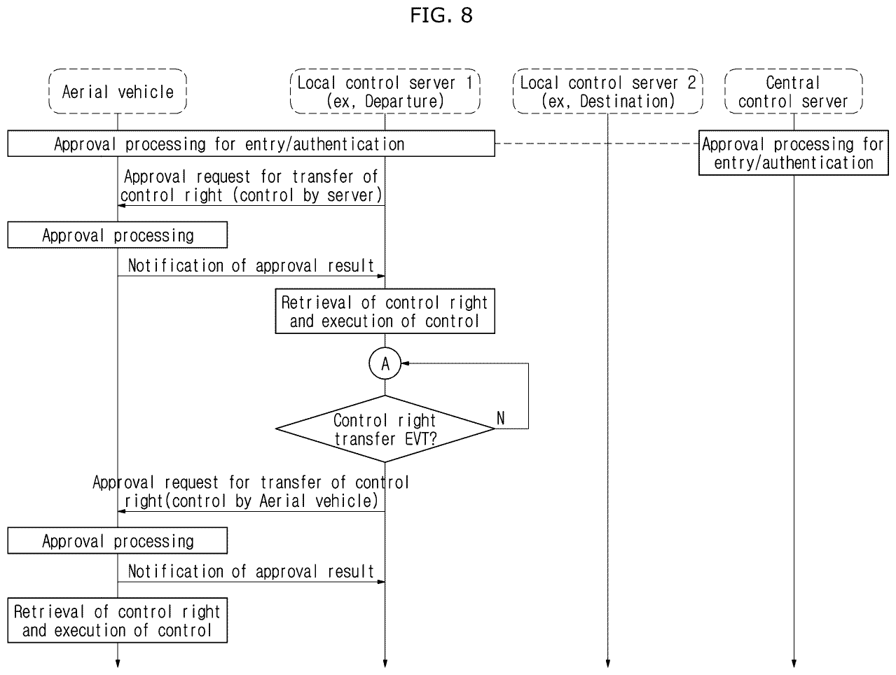

FIG. 8 is a signal flow diagram illustrating a control right transfer operation of an aerial vehicle control system according to an embodiment of the present disclosure.

Specifically, FIG. 8 illustrates a control right transfer operation in a local control server of a departure.

Referring to FIG. 8, first, a personal aerial vehicle, a local control server and a central control server may process approval for entry of the personal aerial vehicle through the above-described approval operation of FIG. 4.

Next, the local control server of the departure may perform control right transfer based on location information of the personal aerial vehicle. Specifically, the local control server may check whether or not the personal aerial vehicle has entered a take-off and landing facility or an entry section, and may transmit a control right transfer request to the personal aerial vehicle. In response to this, the personal aerial vehicle may process approval and provide a result of the approval process to the local control server. Herein, the approval process of the personal aerial vehicle may be implemented by a user of the personal aerial vehicle. As an example, information requesting control right transfer may be shown on a display installed in the personal aerial vehicle or on a device connected with the personal aerial vehicle, and as the user generates an input for approving control right transfer, the approval process of the personal aerial vehicle may be completed.

Next, the local control server may retrieve the control right and may control the personal aerial vehicle. Next, the local control server may identify whether or not an event for control right transfer occurs, based on location information of the personal aerial vehicle. For example, the personal aerial vehicle or the local control server may identify whether or not the personal aerial vehicle enters an aerial vehicle operation zone, and as the personal aerial vehicle enters the aerial vehicle operation zone, may generate an event for control right transfer.

When the event for control right transfer occurs, the local control server may transmit a control right transfer request to the personal aerial vehicle. In response to this, the personal aerial vehicle may process the approval and provide a result of the approval process to the local control server. Likewise, the approval process of the personal aerial vehicle may be implemented by a user of the personal aerial vehicle. As described above, information requesting control right transfer may be shown on a display installed in the personal aerial vehicle or on a device connected with the personal aerial vehicle, and as the user generates an input for approving control right transfer, the approval process of the personal aerial vehicle may be completed. In response to this, the personal aerial vehicle may transmit an approval result of control right transfer to the local control server and perform control for the personal aerial vehicle by retrieving the control.

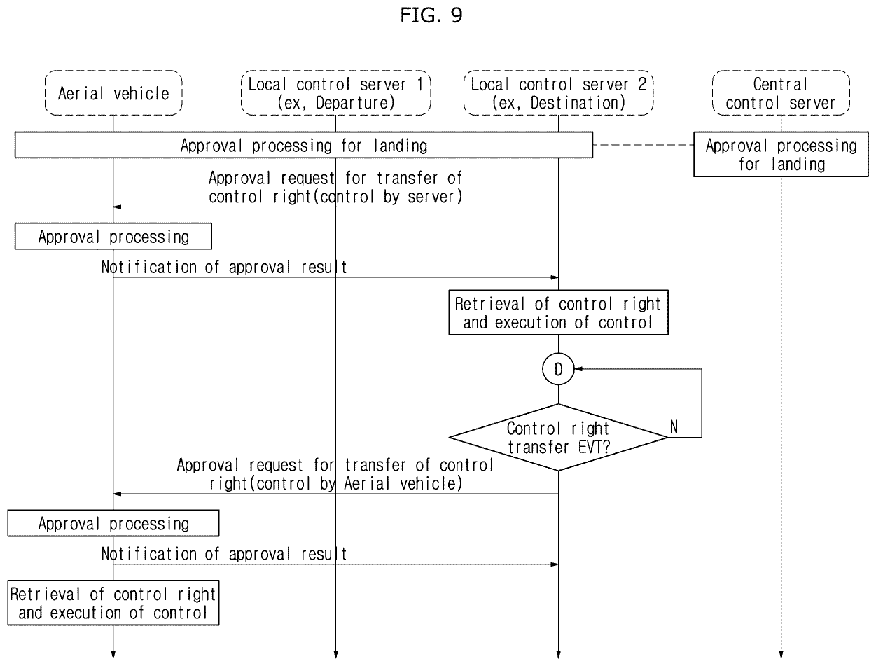

FIG. 9 is a signal flow diagram illustrating a control right transfer operation of an aerial vehicle control system according to an embodiment of the present disclosure.

Specifically, FIG. 9 illustrates a control right transfer operation in a local control server of a destination.

Referring to FIG. 9, first, a personal aerial vehicle, a local control server and a central control server may process approval for exit of the personal aerial vehicle through the above-described approval operation of FIG. 4.

Next, the local control server of the destination may perform control right transfer based on location information of the personal aerial vehicle. Specifically, the local control server may check whether or not the personal aerial vehicle has entered an exit section, and may transmit a control right transfer request to the personal aerial vehicle. In response to this, the personal aerial vehicle may process approval and provide a result of approval process to the local control server. Herein, the approval process of the personal aerial vehicle may be implemented by a user of the personal aerial vehicle. As an example, information requesting control right transfer may be shown on a display installed in the personal aerial vehicle or on a device connected with the personal aerial vehicle, and as the user generates an input for approving control right transfer, the approval process of the personal aerial vehicle may be completed.

Next, the local control server may retrieve the control right and may control the personal aerial vehicle. Next, the local control server may identify whether or not an event for control right transfer occurs, based on location information of the personal aerial vehicle. For example, the personal aerial vehicle or the local control server may identify whether or not the personal aerial vehicle enters a take-off and landing facility (e.g., stop), and as the personal aerial vehicle enters the take-off and landing facility, may generate an event for control right transfer.

When the event for control right transfer occurs, the local control server may transmit a control right transfer request to the personal aerial vehicle. In response to this, the personal aerial vehicle may process the approval and provide a result of the approval process to the local control server. Likewise, the approval process of the personal aerial vehicle may be implemented by a user of the personal aerial vehicle. As described above, information requesting control right transfer may be shown on a display installed in the personal aerial vehicle or on a device connected with the personal aerial vehicle, and as the user generates an input for approving control right transfer, the approval process of the personal aerial vehicle may be completed. In response to this, the personal aerial vehicle may transmit an approval result of control right transfer to the local control server and perform control for the personal aerial vehicle by retrieving the control right.

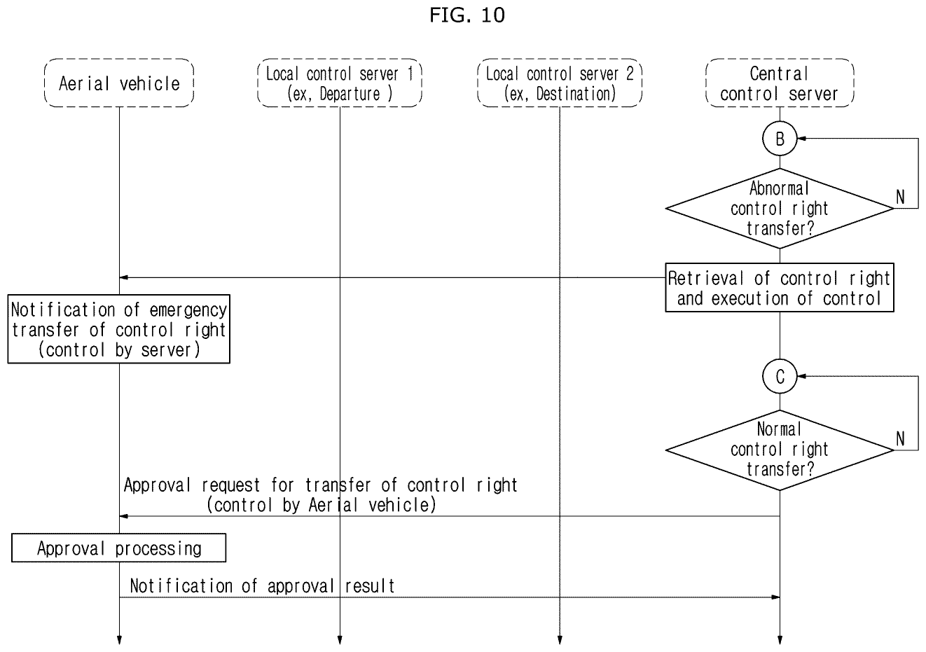

FIG. 10 is a signal flow diagram illustrating a control right transfer operation of an aerial vehicle control system according to an embodiment of the present disclosure.

Specifically, FIG. 10 illustrates an operation of a central control server for transferring a control right in an abnormal situation.

Referring to FIG. 10, first, a personal aerial vehicle is being moved or operated in an aerial vehicle operation zone and is capable of identifying occurrence of an event for an abnormal situation. For example, the abnormal situation may be local strong wind, lightning, a storm and the like. The occurrence of an event for such an abnormal situation may be detected by the personal aerial vehicle or a central control server.

When detecting an event for an abnormal situation, the central control server may retrieve control of the personal aerial vehicle to the central control server and perform control for the personal aerial vehicle.

Unlike the control right transfer operations of FIG. 8 and FIG. 9, control right transfer to the central control server may be executed without an approval operation in an abnormal situation. At this time, the central control server may retrieve the control right of the personal aerial vehicle first. Specifically, the central control server may keep communicating with the personal aerial vehicle, which enters the aerial vehicle operation zone, through a control channel and transmit a forced control right transfer command to the personal aerial vehicle, of which the control right transfer is required. In response to this, the personal aerial vehicle may transfer control right to the central control server and deliver a transfer completion message to the central control server. Next, the personal aerial vehicle may show information notifying the forced control right transfer on a display installed in the personal aerial vehicle or on a device connected with the personal aerial vehicle.

Meanwhile, the central control server may transfer the control right by force and perform control for the personal aerial vehicle. Next, the central control server may check a situation of the aerial vehicle operation zone and monitor whether or not an abnormal situation is over. In case the abnormal situation is over, that is, in case the abnormal situation changes to a normal situation, the central control server may return the control right to the personal aerial vehicle. For example, the central control server may transmit a control right transfer request to the personal aerial vehicle. In response to this, the personal aerial vehicle may process the approval and provide a result of the approval process to the central control server. Likewise, the approval process of the personal aerial vehicle may be implemented by a user of the personal aerial vehicle. As described above, information requesting control right transfer may be shown on a display installed in the personal aerial vehicle or on a device connected with the personal aerial vehicle, and as the user generates an input for approving control right transfer, the approval process of the personal aerial vehicle may be completed. In response to this, the personal aerial vehicle may transmit an approval result of control right transfer to the central control server and perform control for the personal aerial vehicle by retrieving the control.

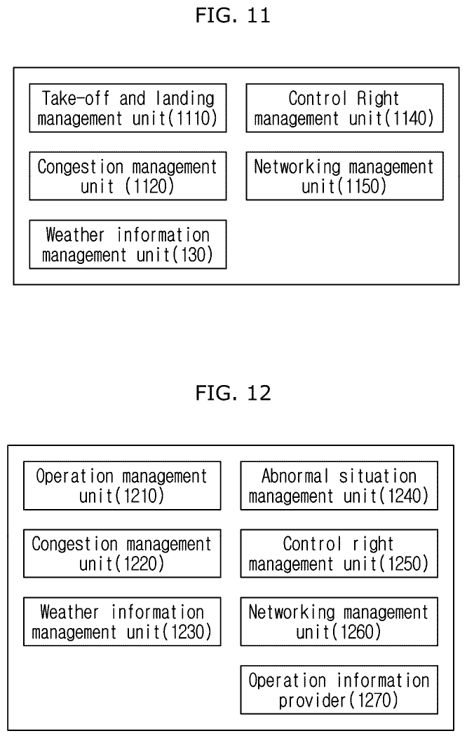

FIG. 11 is a block diagram illustrating a configuration of a local control server for an aerial vehicle control system according to an embodiment of the present disclosure.

Referring to FIG. 11, a local control server may include a take-off and landing management unit 1110, a congestion management unit 1120, a weather information management unit 1130, a control right management unit 1140, and a networking management unit 1150.

The take-off and landing management unit 1110 may manage an occupancy state of a take-off and landing facility, a state of a supplementary take-off and landing field, information on a personal aerial vehicle for which take-off is approved, information on a personal aerial vehicle which enters a take-off and landing field, reservation information of take-off and landing, and the like.

For example, in the management of an occupancy state of a take-off and landing facility, identification numbers of stops and take-off and landing fields, which are included in the take-off and landing facility, may be managed, and information on a moving object or a personal aerial vehicle, which stops in a stop or a take-off and landing field, may be managed. Furthermore, an aerial vehicle control system may operate and manage a supplementary take-off and landing field, and the take-off and landing management unit 1110 may manage information on a personal aerial vehicle that stops, takes off or lands at the supplementary take-off and landing field.

In addition, the take-off and landing management unit 1110 may store and manage information on a personal aerial vehicle, for which a take-off or landing approval is requested, and user information. For example, the take-off and landing management unit 1110 may store temporarily information on a personal aerial vehicle, for which a take-off approval is requested, and user information and, when the personal aerial vehicle enters an aerial vehicle operation zone, may deliver the information on the personal aerial vehicle and the user information to a central control server and then delete the temporarily stored information. In addition, the take-off and landing management unit 1110 may store information on a personal aerial vehicle, for which a landing approval is requested, and user information and, when the personal aerial vehicle enters a take-off and landing field or a stop, may store and manage the information on the personal aerial vehicle and the user information. Furthermore, when the personal aerial vehicle, which was present in the take-off and landing field or the stop, goes out of the take-off and landing field or the stop through a road zone, the take-off and landing management unit 1110 may delete the information on the personal aerial vehicle and the user information.

In addition, the take-off and landing management unit 1110 may receive reservation information of a personal aerial vehicle from a central control server and may store and manage the received reservation information of the personal aerial vehicle. The reservation information of the personal aerial vehicle, which is provided by the central control server, may include information on the personal aerial vehicle that is managed by a corresponding local control server.

The congestion management unit 1120 may check and manage a degree of congestion for a corresponding take-off and landing facility based on occupancy information of the take-off and landing facility and reservation information of a personal aerial vehicle. In addition, the congestion management unit 1120 may receive destination information of a personal aerial vehicle, which is being operated in an aerial vehicle control system, from the central control server, predict a degree of congestion for a take-off and landing facility by reflecting an arrival time of the personal aerial vehicle at the take-off and landing facility of the destination, and manage a degree of congestion for the take-off and landing facility by using predicted information.

The weather information management unit 1130 may receive and store central weather information provided by the central control server. In addition, the weather information management unit 1130 may store and manage local weather information that is detected through a weather observation device installed at a corresponding take-off and landing facility. In addition, the weather information management unit 1130 may provide local weather information to the central control server.

The control right management unit 1140 may check location information of a personal aerial vehicle and retrieve the control right for a personal aerial vehicle that approaches a take-off and landing field, an entry section, and an exit section. In addition, the control right management unit 1140 may return the control right for a personal aerial vehicle, which enters an aerial vehicle operation zone, based on location information of the personal aerial vehicle. For the control right retrieval and return operations of the control right management unit 1140, the above-described operations of FIG. 8 and FIG. 9 may be referred to.

The networking management unit 1150 may manage the connection and maintenance with the central control server and the connection and maintenance with a neighboring local control server. In addition, the networking management unit 1150 may manage connection with a moving object or a personal aerial vehicle.

FIG. 12 is a block diagram illustrating a configuration of a central control server for an aerial vehicle system according to an embodiment of the present disclosure.

Referring to FIG. 12, a central control server may include an operation management unit 1210, a congestion management unit 1220, a weather information management unit 1230, an abnormal situation management unit 1240, a control right management unit 1250, and a networking management unit 1260.

The operation management unit 1210 may manage information related to an operation of a personal aerial vehicle that enters an aerial vehicle operation zone. For example, the operation management unit 1210 may store and manage the departure information, destination information and real-time location information of the personal aerial vehicle.

The operation management unit 1210 may check and manage charging information for a personal aerial vehicle that enters and exits an aerial vehicle operation zone.

The congestion management unit 1220 may check and manage congestion information of each section in an aerial vehicle operation zone based on the departure information, destination information and real-time location information of a personal aerial vehicle.

The weather information management unit 1230 may check and store central weather information. In addition, the weather information management unit 1230 may store central weather information in a local control server. The weather information management unit 1230 may receive and store local weather information from a local control server.

The abnormal situation management unit 1240 may monitor whether or not an abnormal situation occurs in a specific location or section, based on congestion information of each section in an aerial vehicle operation zone and central weather information. When an abnormal situation occurs, the abnormal situation management unit 1240 may transmit an event of occurrence of the abnormal situation to a personal aerial vehicle or a local control server.

The control right management unit 1250 may identify an event of occurrence of an abnormal situation and retrieve the control right for a personal aerial vehicle according to the occurrence of an event of an abnormal situation. In addition, the control right management unit 1250 may return the control right for the personal aerial vehicle to the personal aerial vehicle, when the abnormal situation is over. For the control right retrieval and return operations of the control right management unit 1250, the above-described operation of FIG. 10 may be referred to.

The networking management unit 1260 may manage the connection and maintenance with a local control server and the connection and maintenance with a neighboring local control server. In addition, the networking management unit 1260 may manage connection with a moving object or a personal aerial vehicle and especially manage connection and maintenance with a personal aerial vehicle in an aerial vehicle operation zone through a control channel.

A central control server may further include an operation information provider 1270. The operation information provider 1270 may provide congestion information of each section of an aerial vehicle operation zone. In addition, the operation information provider 1270 may provide central weather information. Furthermore, the operation information provider 1270 may provide such congestion information or central weather information to a personal aerial vehicle through broadcasting.

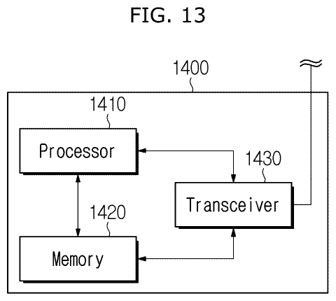

FIG. 13 is a view illustrating an apparatus configuration according to an embodiment of the present disclosure.

Referring to FIG. 13, the apparatus may include at least one of the above-described moving object, a device, a server and an RSU. In other words, the apparatus may be configured to communicate and work with another device. The present disclosure is not limited to the above-described embodiment. For example, for the above-described operation, an apparatus 1400 may include one or more among a processor 1410, a memory 1420, and a transceiver 1430. In other words, the apparatus may include a necessary configuration for communicating with another apparatus. In addition, the apparatus may include another configuration apart from the above-described configuration. In other words, the apparatus may have a configuration, which includes the above-described apparatus for communicating with another device but is not limited thereto, and may be operated based on what is described above.

Although the exemplary methods of embodiments of the present disclosure described above are represented by a series of acts for clarity of explanation, they are not intended to limit the order in which the steps are performed, and if necessary, each step may be performed simultaneously or in a different order. In order to implement a method according to embodiments of the present disclosure, the illustrative steps may include an additional step or exclude some steps while including the remaining steps. Alternatively, some steps may be excluded while additional steps are included.

The various exemplary embodiments of the disclosure are not intended to be all-inclusive and are intended to illustrate representative aspects of the disclosure, and the features described in the various exemplary embodiments may be applied independently or in a combination of two or more. In addition, the various exemplary embodiments of the present disclosure may be implemented by hardware, firmware, software, or a combination thereof. In the case of hardware implementation, one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, a microprocessor, and the like may be used for implementation.

The scope of the present disclosure includes software or machine-executable instructions (for example, an operating system, applications, firmware, programs, etc.) that enable operations according to the methods of various exemplary embodiments to be performed on a device or computer, and a non-transitory computer-readable medium in which such software or instructions are stored and are executable on a device or computer.

What is claimed is:

1. A method for controlling operation of an aerial vehicle in an aerial vehicle control system, the method comprising:
approving entry of the aerial vehicle into an aerial vehicle operation zone from a take-off and landing facility of a departure location built into the aerial vehicle control system;
controlling an operation of the aerial vehicle in the aerial vehicle operation zone; and
approving exit of the aerial vehicle from the aerial vehicle operation zone into a take-off and landing facility of a destination location,
wherein the aerial vehicle operation zone includes a first operation zone and a second operation zone, and the first operation zone is managed as a course above the second operation zone,
wherein the aerial vehicle operation zone comprises a supplementary operation zone set by expanding the aerial vehicle operation zone based on location of an obstacle, and the supplementary operation zone is predefined before the aerial vehicle is approved to enter the aerial vehicle operation zone.

2. The method of claim 1, wherein the aerial vehicle operation zone is set based on a road zone in which a ground-based vehicle is operated.

3. The method of claim 1, wherein the aerial vehicle operation zone is set at a predetermined height above a road zone in which a ground-based vehicle is operated.

4. The method of claim 1, wherein the aerial vehicle operation zone is set at a predetermined height above a neighboring zone of a road zone in which a ground-based vehicle is operated.

5. The method of claim 4, wherein the neighboring zone of the road zone is set as a preset distance zone from the road zone.

6. The method of claim 1, wherein a first aerial vehicle moving in the first operation zone and a second aerial vehicle moving in the second operation zone are set according to a type of the first aerial vehicle and the second aerial vehicle.

7. The method of claim 1, wherein the first operation zone is set as a relatively higher zone than the second operation zone.

8. The method of claim 1, wherein controlling an operation of the aerial vehicle comprises checking a speed of the aerial vehicle and setting, based on the checked speed, the aerial vehicle operation zone in which the aerial vehicle is to be operated.

9. The method of claim 1, wherein a location of the supplementary operation zone, a size of the supplementary operation zone, or a shape of the supplementary operation zone is adaptively set based on a type of obstacle in the aerial vehicle operation zone.

10. The method of claim 9, wherein the supplementary operation zone is set by expanding the aerial vehicle operation zone either vertically or horizontally when the obstacle is a fixed obstacle.

11. The method of claim 10,. wherein the supplementary operation zone is set by selecting one of 8 directions as an optimal evasion zone when the obstacle is a movable obstacle.

12. The method of claim 1, wherein the take-off and landing facility is located close to a ramp section of an expressway or a service facility of the expressway.

13. An apparatus for controlling operation of an aerial vehicle in an aerial vehicle control system,
the apparatus comprising a processor configured to,
approve entry of the aerial vehicle into an aerial vehicle operation zone from a take-off and landing facility of a departure location built into the aerial vehicle control system;
control an operation of the aerial vehicle in the aerial vehicle operation zone; and
approve exit of the aerial vehicle from the aerial vehicle operation zone into a take-off and landing facility of a destination location,
wherein the aerial vehicle operation zone includes a first operation zone and a second operation zone, and the first operation zone is managed as a course above the second operation zone,
wherein the aerial vehicle operation zone comprises a supplementary operation zone set by expanding the aerial vehicle operation zone based on location of an obstacle, and the supplementary operation zone is predefined before the aerial vehicle is approved to enter the aerial vehicle operation zone.

14. The apparatus of claim 13, wherein the aerial vehicle operation zone is set based on a road zone in which a ground-based vehicle is operated.

15. The apparatus of claim 13, wherein the aerial vehicle operation zone is set at a predetermined height above a road zone in which a ground-based vehicle is operated.

16. The apparatus of claim 13, wherein the aerial vehicle operation zone is set at a predetermined height above a neighboring zone of a road zone in which a ground-based vehicle is operated.

17. The apparatus of claim 16, wherein the neighboring zone of the road zone is set as a preset distance zone from the road zone.

18. The apparatus of claim 13, wherein a first aerial vehicle moving in the first operation zone and a second aerial vehicle moving in the second operation zone are set according to a type of the first aerial vehicle and the second aerial vehicle.

19. The apparatus of claim 13, wherein the first operation zone is set as a relatively higher zone than the second operation zone.

20. The apparatus of claim 13, wherein the processor is further configured to check a speed of the aerial vehicle and set the aerial vehicle operation zone in which the aerial vehicle is to be operated based on the checked speed.
